(19) United States
(12) Patent Application Publication
(10) Pub. No.: US 2007/0139691 A1
(43) Pub. Date: Jun. 21, 2007

(54) Printer

(75) Inventor: Shinichi Shikii, Kanagawa (JP)

Correspondence Address: SUGHRUE-265550, 2100 PENNSYLVANIA AVE. NW, WASHINGTON, DC, 20037-3213, US

(73) Assignee: FUJIFILM Corporation, Tokyo (JP)

(21) Appl. No.: 11/639,213

(22) Filed: Dec. 15, 2006

(30) Foreign Application Priority Data
Dec. 15, 2005 (JP) 2005-362071

(51) Int. Cl. G06K 15/00

(52) U.S. Cl. 358/1.14

(57) ABSTRACT

A printer with an output image quality control function, comprising: a pattern storage portion for storing evaluation patterns to evaluate quality test items; a pattern output time storage portion for storing output times of the evaluation patterns to evaluate the quality test items; and a print control portion for determining a layout of an evaluation pattern coming into an output time on a recording material based on information of the pattern output time storage portion, and outputting the evaluation pattern from the pattern storage portion onto the recording material.

### FIELD OF THE INVENTION

The present invention relates to a technical field of various printers such as a thermal recording system, a photo-thermographic system, etc., and particularly relates to printers in which quantitative control (quality control of images, which will be referred to as “QC” and especially “printer QC” as quality control of printer images) can be performed in the installation site.

### BACKGROUND OF THE INVENTION

Various diagnostic image acquisition systems using X-rays or the like have been heretofore used in the medical field. X-ray machines, CR (Computed Radiography) machines, CT (Computed tomography) machines, MRI (Magnetic Resonance Imaging) machines, etc. have been put to practical use.

Medical image information acquired by these machines is reproduced as a hard copy on a recording material such as a film or the like by a printer, and used for medical diagnosis by experts.

For such medical diagnosis based on an image, a monochrome (black and white) image is typically used, and a microscopic structure is observed through a difference of density in the image. Accordingly, the medical diagnosis image is required to have enough high sharpness. It is therefore necessary to perform printer QC such that a fixed quality can be always kept.

In recent years, there has been a request to define managerial responsibility of medical equipment. From such a request, it has been required to grasp quality control by users, and the equipment has been required to be able to acquire its quality control data easily in the installation site.

In the background art, here, the quality control data can be grasped through a print of evaluation patterns. Suitable time of testing differs from one quality control item to another. Evaluation patterns have to be outputted every suitable time of testing. However, periodical testing may be forgotten, or printing the evaluation patterns may be forgotten. Further, testing must be frequently carried out for some quality control items. There is also a problem that use of recording materials increases in accordance with the number of test items.

As background arts, JP-A-2004-237533 and JP-A-2004-122443 are known.

### SUMMARY OF THE INVENTION

The present invention was developed in consideration of the aforementioned problems. An object of the invention is to provide a printer with an output image quality control function in which quality control data can be acquired easily and surely and the usage of recording materials can be suppressed.

The aforementioned object of the invention is attained by the following configurations:

(1) A printer with an output image quality control function, including a pattern storage portion for storing evaluation patterns to evaluate quality test items; a pattern output time storage portion for storing output times of the evaluation patterns to evaluate the quality test items; and a print control portion for determining a layout of an evaluation pattern coming into an output time on a recording material based on information of the pattern output time storage portion, and outputting the evaluation pattern from the pattern storage portion onto the recording material.

(2) A printer according to the configuration (1), wherein the evaluation patterns outputted by the print control portion are recorded on a sheet of the recording material.

Suitable evaluation patterns are printed thus in accordance with output times set for equality test items respectively. It is therefore possible to prevent forgetting to perform a periodical test or forgetting to print evaluation patterns. Thus, it is possible to prevent forgetting to acquire control data.

Further, evaluation patterns to be outputted at one and the same time are aggregated on a sheet of the recording material. Thus, the number of sheets of the recording material to be used for test data can be reduced as compared with the case where evaluation patterns are recorded for each test item.

According to the invention, it is possible to provide a printer with an output image quality control function in which patterns for quality test items showing quality control data can be acquired easily and surely and the usage of recording materials can be suppressed.

### BRIEF DESCRIPTION OF THE DRAWINGS

FIG. 1 is a schematic side view showing the configuration of a thermal recording printer with a measuring function according to an embodiment of the invention.

FIG. 2 is a block diagram showing the schematic configuration of an image quality measuring function portion 24 with an outputted image quality control (QC) function according to the invention.

FIG. 3 is a view showing patterns for use in density measuring.

FIGS. 4A and 4B are explanatory views showing a visual evaluation pattern in this embodiment.

FIG. 5 is a flow chart for explaining the operation of the outputted image quality control (QC) function in this embodiment shown in FIG. 2.

### DETAILED DESCRIPTION OF THE INVENTION

An embodiment of the invention will be described below in detail with reference to the accompanying drawings.

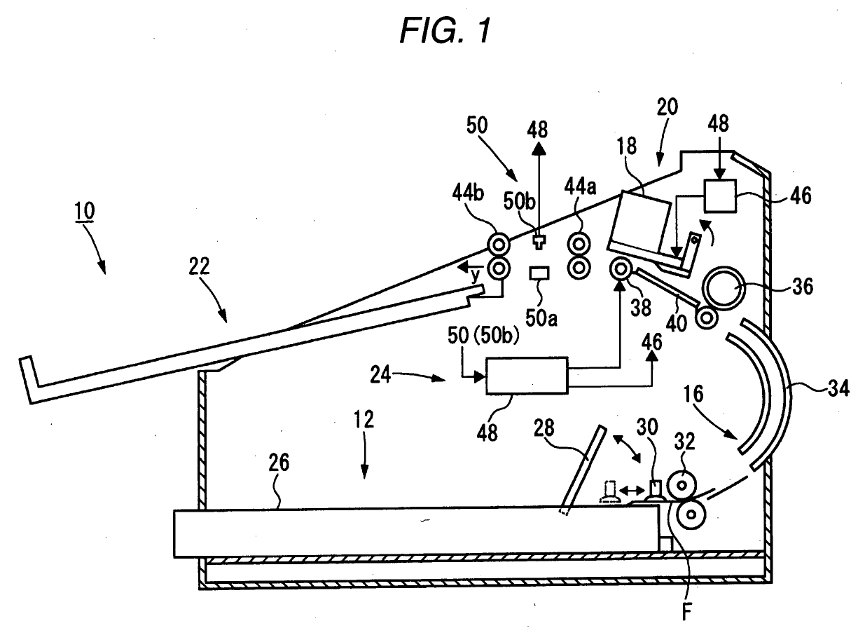

FIG. 1 is a schematic side view showing the configuration of a thermal recording printer with a measuring function according to an embodiment of the present invention.

A printer 10 shown in FIG. 1 performs thermal image recording on a thermal recording material such as an optically transparent thermal recording film (hereinafter referred to as “film” simply) F having a predetermined size such as a half size. The printer 10 has a loading portion 12, a conveyance portion 16, a recording portion 20, a tray 22 and an image quality measuring function portion 24. The recording portion 20 has a print control portion for performing thermal image recording on the film F by means of a thermal head 18 and outputting evaluation patterns. The tray 22 receives the recorded film.

The film F has a base made of transparent PET (polyethylene terephthalate) or the like. A thermal recording layer is formed on one side of the base. Predetermined units, for example, about 100 sheets of films F are stacked and received in a dedicated magazine 26.

This magazine 26 has a cover 28. The magazine 26 is inserted into the printer 10 through an insertion hole formed in the printer 10, and loaded in a predetermined position of the loading portion 12 by a known means using a guide, a stopper or the like.

The conveyance portion 16 has a function to extract the film F from the magazine 26 loaded in the loading portion 12 and convey the extracted film F to the recording portion 20. The conveyance portion 16 has a sheet feeding mechanism using a sucker 30 for sucking the film F, a conveyance roller pair 32, a conveyance guide 34, a cleaning roller pair 36, a not-shown opening/closing mechanism, etc.

First, description will be made about the outline of the fundamental operation of the printer 10 in the aforementioned configuration according to this embodiment.

When an instruction to start recording is issued in the printer 10, the aforementioned opening/closing mechanism opens the cover 28 of the magazine 26, and the sucker 30 sucks a sheet of film F, extracts the sucked film F from the magazine 26, and supplies the extracted film F to the conveyance roller pair 32. The film F supplied to the conveyance roller pair 32 is guided by the conveyance guide 34 so as to be conveyed to the cleaning roller pair 36. The film F is sent to the recording portion 20 while dust, grime or the like adhering to the recording surface of the film F is removed by the cleaning roller shown in the upper of FIG. 1.

The recording portion 20 has a thermal head 18, a platen roller 38, a conveyance guide 40, a discharge roller pair 44a and 44b, a head driving control portion 46, a cooling fan (not shown) for the thermal head 18, etc.

The thermal head 18 is a known thermal head including a thermal head body and a heat sink fixed to the thermal head body. The thermal head body has a thermal storage layer (glaze layer), heating elements and a glaze. The heating elements are made of heating resistors and electrodes and arrayed in one direction (main scanning direction, which is a direction perpendicular to the paper of FIG. 1). The glaze is made of a protective layer or the like. Each heating element of the thermal head 18 is driven to be, for example, pulse-modulated in according to a recorded image by a head driving control portion 46.

Here, evaluation patterns outputted by a QC (Quality Control) function which will be described later, such as test patterns for measuring sharpness, are recorded as a recorded image (or a part thereof) according to a predetermined recording system (as will be described later in detail).

The platen roller 38 rotates the film F in a predetermined velocity while retaining the film F in a predetermined position. The film F is put between the platen roller 38 and the thermal head 18 (or its glaze). The platen roller 38 conveys the film F at a predetermined recording speed in a sub-scanning direction perpendicular to the main scanning direction.

The film F conveyed through the cleaning roller pair 36 is put between the platen roller 38 and the thermal head 18 (glaze thereof) and conveyed in the sub-scanning direction in that state. Thus, the film F is scanned by the thermal head 18 (heating element array). In parallel to this conveyance, the head driving control portion 46 drives each heating element of the thermal head 18 in accordance with image data so as to heat each heating resistor. Thus, the film F is heated and colored correspondingly so that an image is recorded.

The film F having the image recorded is conveyed by the discharge roller pair 44a and 44b and discharged to the tray 22 as a hard copy.

The image quality measuring function portion 24 controls (checks) the quality of the image in the printer 10 by use of evaluation patterns for measuring the image quality, which patterns are recorded in the film F. The image quality measuring function portion 24 has an image quality measuring control portion 48 and an image quality measuring portion 50.

The image quality measuring control portion 48 outputs records of evaluation patterns for measuring image quality to the film F in accordance with at least the recording time of each item to be measured. Further in this embodiment, the image quality measuring control portion 48 sets the layout of the evaluation patterns on one sheet of film, and controls various processes in accordance with measurement of the evaluation patterns and results of the measurement. In these operations, if necessary, the image quality measuring control portion 48 gives an instruction to the head driving control portion 46 to record the aforementioned evaluation patterns by the means of the thermal head 18, or to receive results of measurement of the recorded evaluation patterns and perform processes in accordance with the received results.

The image quality measuring portion 50 measures the evaluation patterns recorded in the conveyed film F between the discharge roller pair 44a and 44b, for example, when QC about sharpness is performed. The image quality measuring portion 50 is constituted by a lighting source 50a and a two-dimensional photo-sensor 50b.

Here, since the optically transparent film F is a target for measurement, the image quality measuring portion 50 is designed to measure transmitted light. However, when the target for measurement is not optically transparent, it is a matter of course that the image quality measuring portion 50 is designed to measure so-called reflected light.

In this measurement, the film F may be temporarily stopped in a predetermined position. This is effective in preventing focal misalignment caused by flipping due to the film F moving during the measurement. To this end, in the printer 10 according to this embodiment, a function to control driving of the discharge roller pair 44a and 44b disposed to hold the image quality measuring portion 50 therebetween is provided to temporarily stop and fix the film F in the measuring position.

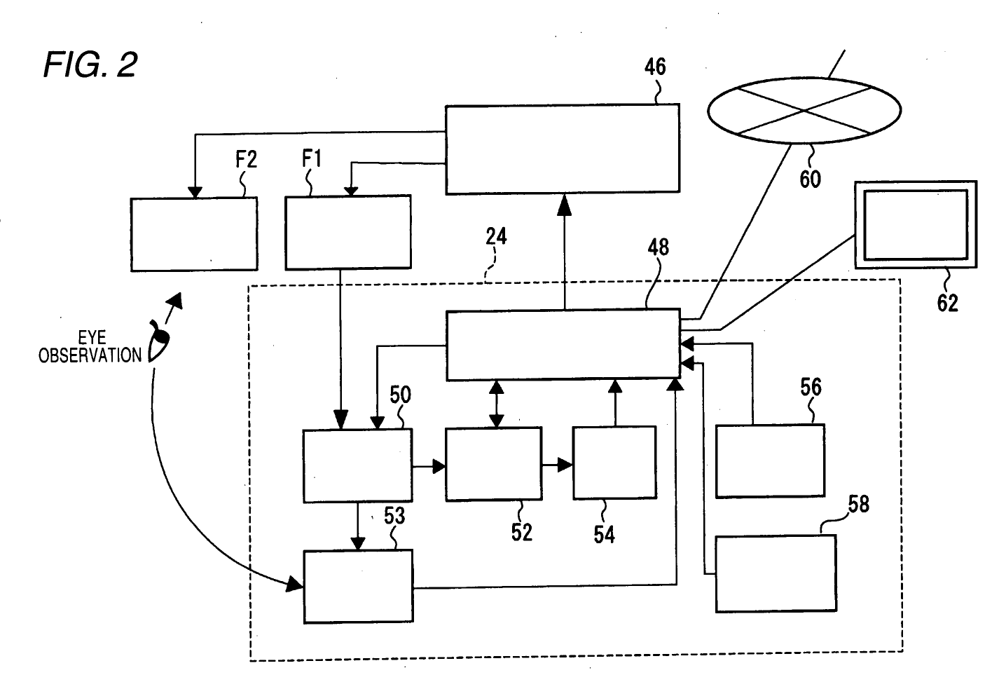

FIG. 2 is a block diagram showing the schematic configuration of the image quality measuring function portion 24 having a quality control (QC) function for an outputted image according to the present invention.

As shown in FIG. 2, in the image quality measuring function portion 24 according to this embodiment, the image quality measuring control portion 48 which is the center of the image quality measuring function portion 24 and also serves as a pattern print control portion is connected to the head driving control portion 46 for outputting an automatic measuring evaluation pattern F1 and a visual evaluation pattern F2 which are evaluation patterns to test quality items of an image. Further, the image quality measuring portion 50, a determination portion 52, a memory 54, an evaluation pattern storage portion 56 and a pattern output time storage portion 58 are connected to the image quality measuring control portion 48. A display 62 for displaying image quality QC results or the like can be also connected to the image quality measuring control portion 48. Further, the image quality measuring control portion 48 can be also connected to an external system or the like through a network 60 such as the Internet.

The printer according to this embodiment is not limited especially, but preferably a medical printer for outputting a transparent monochrome film. Such a medical printer is preferably a dry printer needing no wet developing process. A preferred example of the medical printer includes a thermal recording apparatus using a thermal head or a heat mode laser, or a photosensitive heat coloring image recording apparatus using a photosensitive heat developing recording material or a photosensitive thermal recording material.

Of the automatic measuring evaluation pattern F1 for automatically measuring the image quality and the visual evaluation pattern F2 for evaluating the image quality by human eyes, patterns of items in due output time are selected based on data in the pattern output time storage portion 58 as described previously. The selected patterns are determined as to their layout on the film F serving as a recording material by the quality measuring control portion 48 based on data prepared in the evaluation pattern storage portion 56 in advance. The determined layout is stored by the head driving control portion 46.

Here, examples of image quality measuring items to be recorded in the automatic measuring evaluation pattern F1 and automatically measured may include density, format, sharpness, etc. At least one of these items of image quality is automatically measured. For example, a pattern to measure density at three points of high density, middle density and low density is used as a density measuring pattern.

A visual SMPTE pattern or a practical clinical image such as a chest or knee X-ray photogram is used as the visual evaluation pattern F2. The SMPTE pattern is a pattern to examine strain, spatial resolution, contrast, artifact, etc. of an image. The practical clinical image is used for testing as to whether there appears a pseudo-contour or not or whether there is a problem as a diagnostic image or not.

These image quality measuring items have their own proper measuring times respectively. Some items have to be measured everyday, and some items have to be measured at an interval of about half a year to a year. Data in the pattern output time storage portion 58 are used.

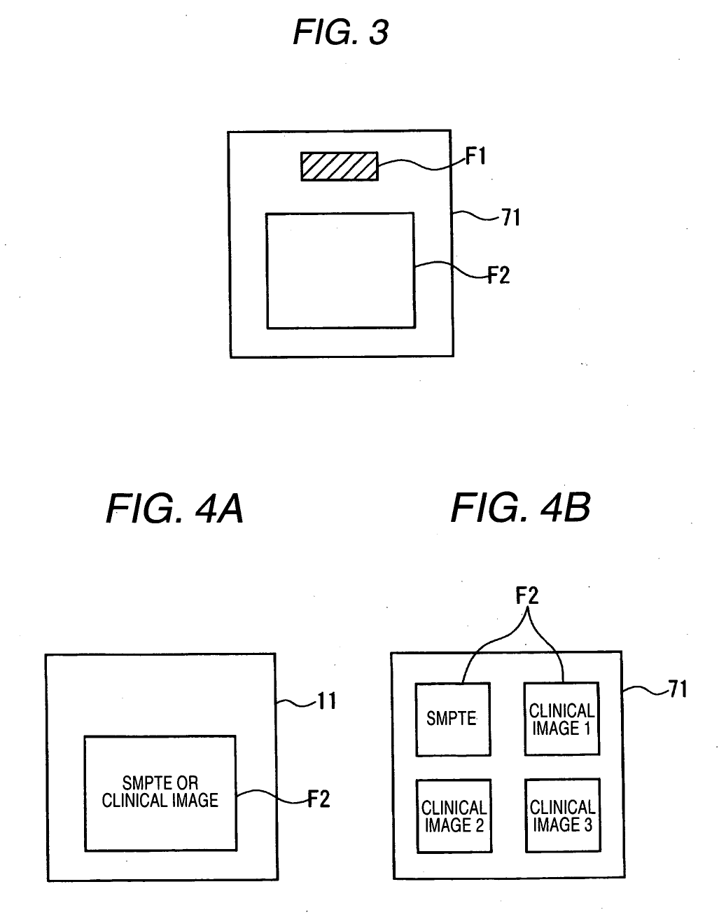

It is preferable that the automatic measuring evaluation pattern F1 and the visual evaluation pattern F2 are recorded in one pattern sheet 71 as shown in FIG. 3. In this manner, both automatic measuring and visual evaluation can be carried out on one pattern sheet 71. Thus, the loss of outputted film can be reduced so that testing can be performed effectively.

As for the visual evaluation pattern F2, only one frame of an SMPTE pattern or a practical clinical image may be outputted to the single pattern sheet 71 as shown in FIG. 4A. Alternatively, an SMPTE pattern and a plurality of practical clinical images may be outputted (as all-in-one output) to the single pattern sheet 71 as shown in FIG. 4B.

In the layout on the single pattern sheet 71, images can be packed in the automatic measuring evaluation pattern F1 and the visual evaluation pattern F2, and arranged in time series so as to be sorted by measuring time. Any other layout can be set and selected optionally.

The image quality measuring portion 50 is a measuring means such as a densitometer as described previously. Measured data are sent to the determination portion 52. The measured data and determination results in the determination portion 52 are recorded in the memory 54.

The visual input portion 53 is a portion for manually inputting results of visual evaluation performed on the visual evaluation pattern F2 by human eyes. The visual evaluation results inputted by the visual input portion 53, the aforementioned measured values, etc. are also stored in the memory 54.

When there is a failure in the image quality measuring portion 50 such as a built-in densitometer or when the image quality measuring portion 50 is not mounted, automatic measuring cannot be carried out in the printer 10. In such a case, the automatic measuring evaluation pattern F1 may be measured by an external measuring means outside the printer 10, and values measured by the means may be inputted into the visual input portion 53. Alternatively, the external measuring means may be connected to the printer 10 so that data can be inputted directly.

The memory 54 stores the measured data (image quality data) automatically measured as described above or the determination results thereof, the image quality test results obtained by visual evaluation, etc. as QC data.

The display 62 can display the QC data or the history of the QC data stored in the memory 54. The display format is not limited especially. An example thereof includes a liquid crystal panel or the like.

The printer 10 can be connected to another printer, a system including the printer, a printer QC system on the printer maker side, etc. through the network 60 so that the QC data etc. can be transmitted to the outside.

The printer 10 can print the QC data from the head driving control portion 46 by itself.

Further, the printer 10 preferably also includes a function to automatically calibrate the built-in image quality measuring portion 50 such as a built-in densitometer. The calibration method is not limited especially. An example thereof includes a method in which a test piece serving as reference is measured by the built-in measuring portion 50, and test is performed by comparing a result of the measurement with a proper value.

The operation of this embodiment will be described below.

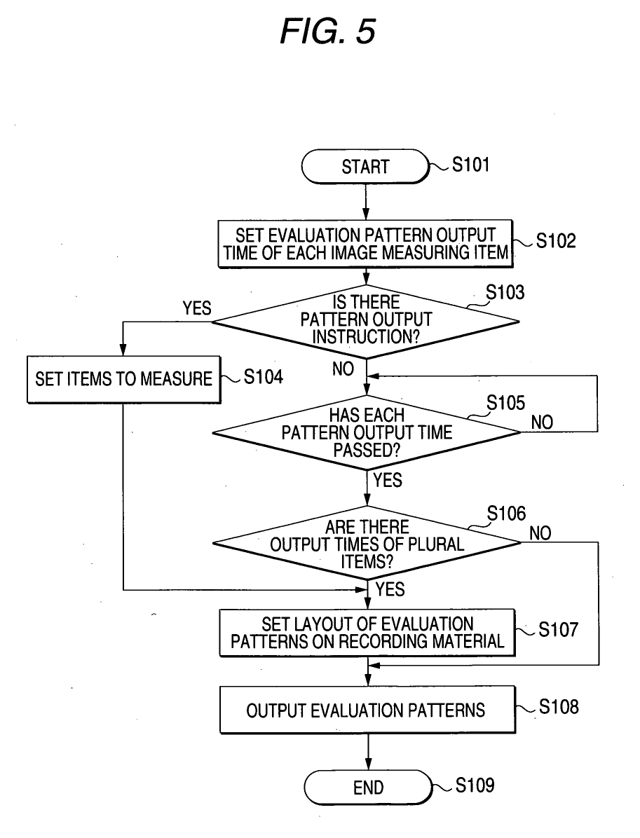

FIG. 5 is a flow chart for explaining the operation of the quality control (QC) function of an output image in this embodiment shown in FIG. 2.

First, in the start of Step S101, as soon as the printer is powered on to start work, a QC program of the image quality measuring function portion 24 may be activated automatically. Alternatively, a user may select a QC menu to activate the QC program of the image quality measuring function portion 24.

Next in Step S102, evaluation pattern output time of each image quality measuring item is set as data of the pattern output time storage portion 58. The data may be inputted as defaults in the printer manufacturing stage. Alternatively, the user may set the data uniquely.

Step S103 is effective in the configuration where the user can issue an instruction to output evaluation patterns desirably. When there is an instruction to output evaluation patterns, the routine of processing moves to Step S104. In Step S104, output items are specified by the input portion 53, and the routine of processing moves to Step S107. In Step S107, the layout of the evaluation patterns on the recording material is determined by the image quality measuring control portion 48. In Step S108, the evaluation patterns are outputted.

When there is not any output instruction in Step S103, the routine of processing moves to Step S105, where the last pattern output of each image quality measuring item is compared with data in the pattern output time storage portion 58, and it is determined whether the evaluation pattern output time of the item becomes due or not. Here, in this embodiment, this step is designed to execute the routine work till the output time becomes due. Generally, however, the printer is usually switched on whenever it is used. In this case, the step may be designed so that the routine of processing moves to Termination Step S109 when it is concluded once in the determination that the output time does not become due.

When it is concluded in Step S105 that the evaluation pattern output time of one image quality measuring item becomes due, the routine of processing moves to Step S106. In Step S106, it is determined whether or not there are a plurality of measuring items whose evaluation pattern output times become due. When there are a plurality of measuring items, the routine of processing moves to Step S107. When there is one measuring item, the routine of processing moves to Step S108, where outputting the evaluation pattern of the item is started.

In Step S107, evaluation patterns corresponding to the plurality of measuring items are read from the evaluation pattern storage portion 56, and the layout on the film F serving as a recording material is set. After that, the routine of processing moves to Step S108, where outputting the evaluation patterns is started. In Step S109, outputting the evaluation patterns is terminated.

In the aforementioned embodiment, evaluation patterns are outputted on the assumption that the printer is powered on. Even if the printer has not been used for a long time, there may occur a problem due to deterioration or nonuse of the printer. Therefore, a clock may be provided in a printer so that evaluation patterns of important items can be outputted forcibly regardless of the power state of the printer.

Here, the automatic measuring evaluation pattern F1 on the pattern sheet 71 is measured by the image quality measuring portion 50 built in the printer 10 before the pattern sheet 71 in which the evaluation pattern has been printed is sent to the outside of the printer 10.

When, for example, the image quality is measured about density, the automatic measuring test pattern F1 is a density measuring pattern composed of three density patterns for high density, middle density and low density. The density patterns are measured by a built-in densitometer of the image quality measuring portion 50. The density measuring is performed by scanning the pattern sheet 71 with the densitometer. The densitometer measures densities at three points of high, middle and low densities on the density measuring patterns. Data measured by the image quality measuring portion 50 are sent to the determination portion 52.

The determination portion 52 makes determination based on the measured values, and sends the measured data and determination results (QC data) to the memory 54. For example, this determination is performed by comparing the measured values obtained by measuring the outputted density measuring patterns, with proper values of data stored in the memory 54 as density measuring patterns in advance.

On the other hand, the pattern sheet 71 where the image quality has been measured automatically is sent to the tray 22 outside the printer 10. The user visually examines the visual evaluation pattern F2 recorded on the pattern sheet 71, and inputs the result of the examination to the printer 10 through the visual input portion 53. The inputted result of the examination is stored and saved in the memory 54.

The QC results are displayed on the display 62 automatically or in response to an instruction given through the input portion 53 by the user. At the same time, the QC data can be printed through the head driving control portion 46 by the printer itself.

The aforementioned embodiment has been described on the case where the invention is applied to a thermal recording apparatus using a thermal head by way of example. The invention is not limited to this, but can be also applied to various other printers such as photo-thermography etc. Especially the invention is preferably applied to a medical printer where importance is attached to the quality control of image quality for the sake of proper diagnosis.

Further, it is also preferable that the aforementioned results of image quality measurements are sent to and accumulated in a suitable database installed in a site different from the site where the printer is installed, via a network. In this case, it is possible to get ready for access from another apparatus connected to the network, such as a supervisory center, a work station, etc.

As has been described above in detail, the printer with an output image quality control function according to the present invention grasps output times of evaluation patterns for image quality, and outputs the patterns to one sheet of recording material automatically. There is a conspicuous effect that it is possible to acquire quality control data easily and surely, and the usage of the recording material can be suppressed.

This application is based on Japanese Patent application JP 2005-362071, filed Dec. 15, 2005, the entire content of which is hereby incorporated by reference, the same as if set forth at length.

What is claimed is:

1. A printer comprising:
a pattern storage portion for storing evaluation patterns to evaluate quality test items;
a pattern output time storage portion for storing output times of the evaluation patterns to evaluate the quality test items; and
a print control portion for determining a layout of an evaluation pattern coming into an output time on a recording material based on information of the pattern output time storage portion, and outputting the evaluation pattern from the pattern storage portion onto the recording material.

2. The printer according to claim 1, wherein the evaluation patterns outputted by the print control portion are recorded on a sheet of the recording material.
